(19) United States
(12) Patent Application Publication
(10) Pub. No.: US 2026/0163292 A1
(43) Pub. Date: Jun. 11, 2026

(54) ELECTRICAL CONNECTOR ASSEMBLY WITH AN IMPROVED PICK-UP CAP

(71) Applicant: FOXCONN INTERCONNECT TECHNOLOGY LIMITED, Grand Cayman (KY)

(72) Inventor: FANG-JWU LIAO, New Taipei (TW)

(21) Appl. No.: 19/413,245

(22) Filed: Dec. 9, 2025

(30) Foreign Application Priority Data
Dec. 10, 2024 (TW) 113213587

(51) Int. Cl. H01R 13/506

(52) U.S. Cl. CPC H01R 13/506

(57) ABSTRACT

An electrical connector assembly includes: an electrical connector comprising a longitudinal insulator with two distal ends and a plurality of terminals retained in the insulator; and a pick-up cap extending longitudinally with two distal ends along a longitudinal direction thereof and having two latch arms connected with corresponding distal ends respectively; wherein each of the latch arms has a latch head at a lower end thereof and an operating portion at an upper end thereof, the insulator has two latch grooves at the two distal ends thereof respectively, and the latch heads engage with corresponding latch grooves respectively to lock the pick-up cap on the insulator.

### BACKGROUND OF THE INVENTION

### Field of the Invention

The present invention relates to an electrical connector assembly with a pick-up cap.

### Description of Related Arts

U.S. Pat. No. 11,830,780 discloses an electrical connector and a pick-up cap. The pick-up cap has a rectangular plate and plural claws extending downward from the rectangular plate. The electrical connector has two half housings. The half housings have plural locking recesses in which the claws are received and latched. As the pick-up cap has plural claws with small size, it is hard to assemble the pick-up cap to the half housings.

Therefore, it is desired to provide an electrical connector assembly with an improved pick-up cap.

### SUMMARY OF THE INVENTION

An object of the present invention is to provide an electrical connector assembly with an improved pick-up cap.

To achieve the above object, an electrical connector assembly comprises: an electrical connector comprising a longitudinal insulator with two distal ends and a plurality of terminals retained in the insulator; and a pick-up cap extending longitudinally with two distal ends along a longitudinal direction thereof and having two latch arms connected with corresponding distal ends respectively; wherein each of the latch arms has a latch head at a lower end thereof and an operating portion at an upper end thereof, the insulator has two latch grooves at the two distal ends thereof respectively, and the latch heads engage with corresponding latch grooves respectively to lock the pick-up cap on the insulator.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector assembly of an embodiment of this invention;

FIG. 2 is another perspective view of the electrical connector assembly in FIG. 1;

FIG. 3 is a perspective view of the electrical connector assembly when a pick-up cap and an electrical connector are separated from each other;

FIG. 4 is another perspective view of the electrical connector assembly in FIG. 3;

FIG. 5 is a top view of the electrical connector assembly in FIG. 1;

FIG. 6 is a side view of the electrical connector assembly in FIG. 1;

FIG. 7 is a bottom view of the electrical connector assembly in FIG. 1; and

FIG. 8 is a cross-sectional view of the electrical connector assembly taken along line A-A of FIG. 1.

### DETAILED DESCRIPTION OF THE PREFERRED EMBODIMENT

Reference will now be made in detail to the preferred embodiments of the present invention.

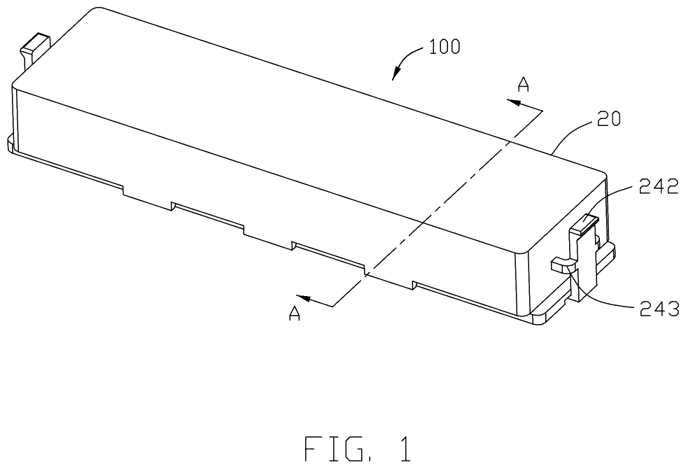

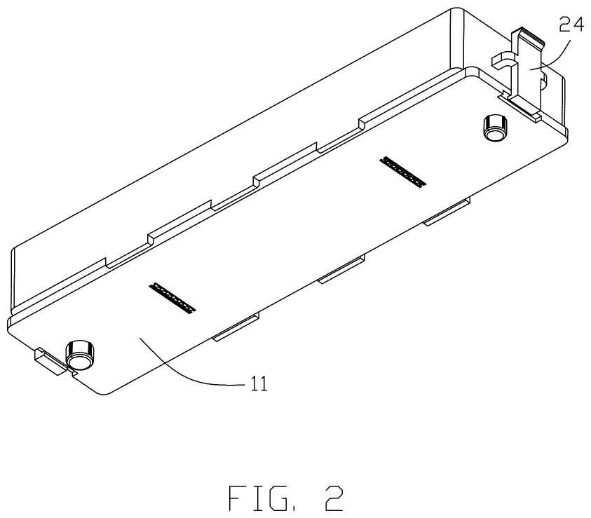

Referring to FIGS. 1-4, an electrical connector assembly 100 of a preferred embodiment includes an electrical connector 10 and a pick-up cap 20 covering the electrical connector 10. The electrical connector 10 is used to electrically connect a chip to a circuit board, alternatively, used to connect two circuit boards. The electrical connector 10 includes an insulator 11 and plural terminals 12 retained in the insulator 11. In the embodiment, only two rows of terminals 12 are shown. In fact, the electrical connector 101 has hundreds terminals 12 arranged in matrix. The pick-up cap 20 on the electrical connector 10 can prevent dust, water, etc. from entering the electrical connector 10. Additionally, the electrical connector assembly 100 can be moved by applying force to the pick-up cap 20 by a jig.

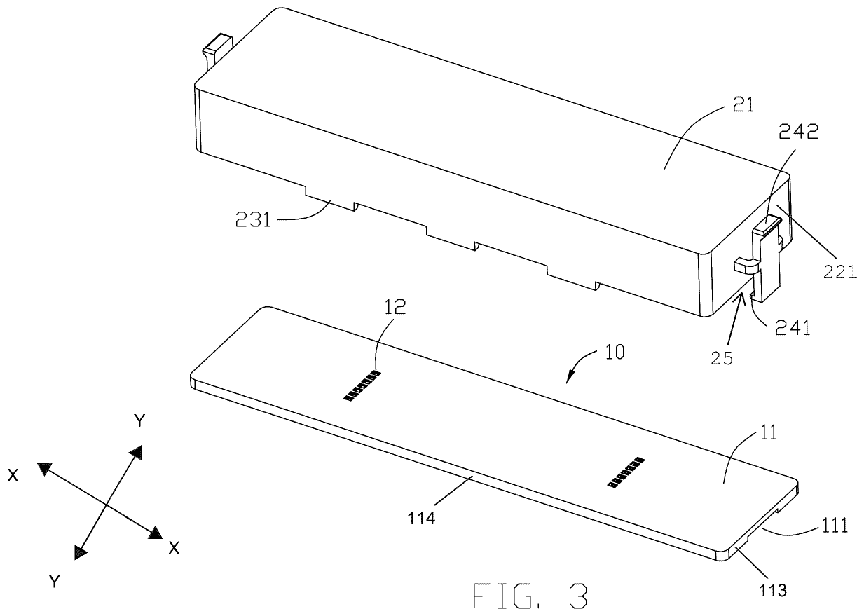

Referring to FIGS. 1-3, the insulator 11 is longitudinal and extends along a first/longitudinal direction X-X and a second/lateral direction Y-Y perpendicular to the first direction as shown in FIG. 3. Correspondingly, the pick-up cap 20 extends along the longitudinal direction X-X and has two opposite distal ends, and each distal end has an end face 221 in the first direction X-X. The pick-up cap 20 has two latch arms 24 connected and gapped with corresponding distal ends/end faces 221 of the pick-up cap respectively, each of the latch arms 24 has a latch head 241 at a lower end thereof and protruding inwards in the first direction, an operating portion 242 at an upper end thereof and protruding outwards in the first direction. The latch arm 24 is connected with corresponding end face 221 by two connecting portions 243.

Preferably, the pick-up cap 20 includes a base board 21 extends in the first direction X-X and the second direction Y-Y, two longitudinal walls and two lateral walls extending downward from the base board 21. The longitudinal walls extend in the longitudinal direction X-X, the lateral walls extend in the lateral direction Y-Y. The lateral walls connect the longitudinal walls. Preferably, the lateral walls include two side walls 23 and the lateral walls include two end walls 22.

Preferably, the insulator 11 is a board and has two latch grooves 111 at two opposite ends in the first direction X-X. The latch grooves 111 recess upward from a lower face of the insulator 11 and penetrate through corresponding end faces 113 of the insulator 11. In other words, the latch grooves 111 open downward and outward in the first direction X-X to facilitate the entry of the latch heads 241 into the latch grooves 111 during the engagement of the cap to the insulator 11.

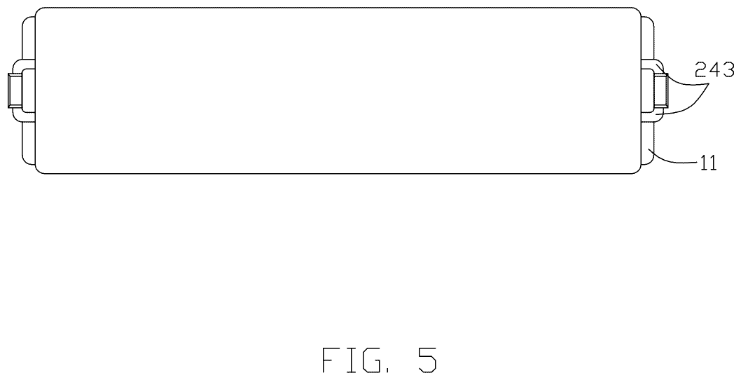

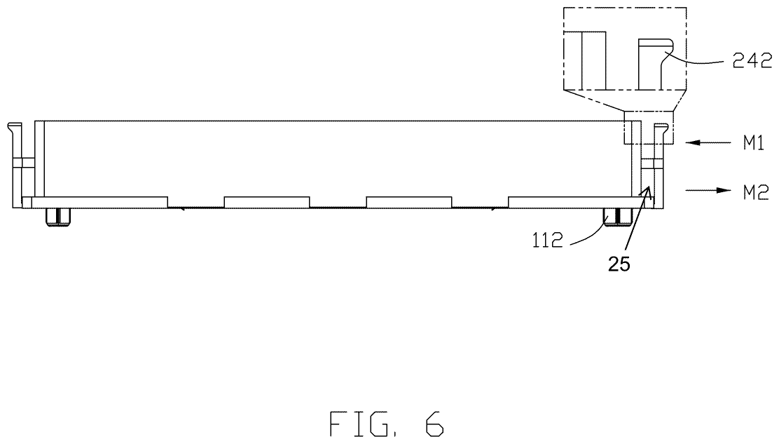

Combined with FIGS. 5-6, the latch head 241 moves in the direction M2 and then is disengaged from the latch groove 111 when the operating portion 242 is pressed inward in a direction M1 in FIG. 6. The latch arms 24 are connected to corresponding end face 221 with two connecting portions 243. A deformation space 25 is defined between the latch arm 24 and corresponding end face 221 and provides a sufficient space for the deformation of the operating portion 242 toward the end face 221. Therefore, the latch heads 242 retract from corresponding latch grooves 111 under an action of the operating portion 242, thereby facilitating the operation of the operating portion 242. Preferably, an upper face of the base board 21 of the pick-up cover 20 is smooth, so as to enable the movement of the electrical connector 10 by adsorption of the pick-up cover 20 by the jig.

Referring to FIGS. 1, 4, and 6, the operating portions 242 are disposed lower than the upper face of the base board 21, the latch heads 241 go downwardly beyond the lower face of the side walls and the end walls to get hooked with the latching grooves 111 while the lower face of the side walls and the end walls abut against the upper face of the insulator, to avoid an interference with the jig.

Referring to FIGS. 1 and 5, in the embodiment, when the pick-up cap 20 is mounted onto the insulator 11, two end faces 113 of the insulator 11 protrude beyond corresponding end faces 221 of the cap 20 in the first direction X-X. That is, the two end faces 113 of the insulator 11 go into the deformation space 25 between the end faces 221 of the pick-up cap 20 and corresponding latch arms 24, and thus the latch heads 241 can lock upwardly with the lower face of the latch groove. Preferably, a lower face of the side walls 23 and the end walls 22 abut against the upper face of the insulator 11 and the latch heads 241 hook an inner face of the latch groove 111 of insulator 11 upwardly, and thus, the pick-up cap 20 and the electrical connector 10 are fixed together in the upper-lower direction. In other embodiments, the latch grooves 111 can be canceled, that is, the insulator 11 has no latch grooves, and the latch heads 241 lock with the lower face of the insulator 11 upwardly directly.

Preferably, the two end faces 113 of insulator 11 abut against corresponding latch arms 24 in the first direction X-X, making the insulator 11 be constrained between the two latch arms 24, and thus, the pick-up cap 20 and the electrical connector 10 are fixed together in the longitudinal direction X.

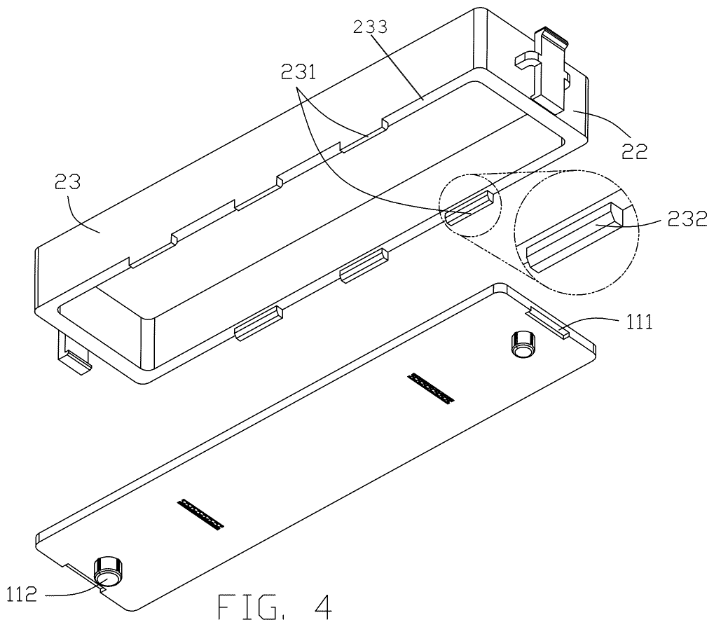

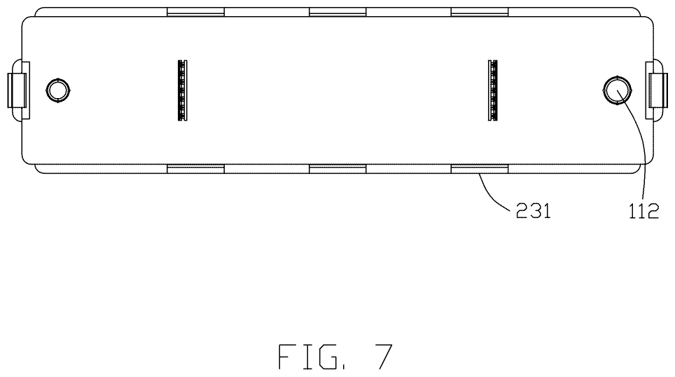

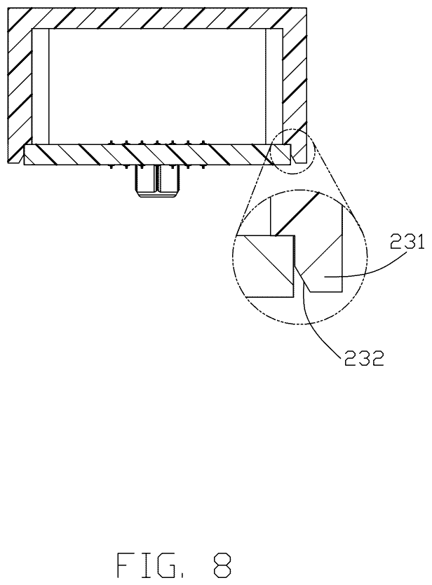

Combined with FIGS. 4 and 7-8, the pick-up cap 20 has plural stopping tabs 231 extending downward from the side walls 23. An outer face of the stopping tab 231 is coplanar with a corresponding outer face of the side wall 23. The stopping tabs 231 are aligned in pairs along the second direction Y-Y. After the pick-up cap 20 is mounted onto the insulator 11, the stopping tabs 231 clamp the insulator 11 in pairs along the second direction Y-Y, making the insulator 11 constrained between the pairs of the stopping tabs 231 of opposite side walls 23, and thus, the pick-up cap 20 and the electrical connector 10 are fixed together in the second direction Y-Y. The stopping tabs 231 only need to be attached to corresponding side faces 114 of the insulator 11, precise alignment is not need. Therefore, the installation of the pick-up cap 20 on the connector is more convenient compared to the prior art.

A thickness of the stopping tabs 231 in the second direction Y-Y is less than a thickness of the side wall 23 to ensure the pick-up cap 20 to be stably mounted on the insulator 11. An outer part of the side wall 23 in the second direction Y-Y extends downward to form the stopping tabs 231. The lower face 233 of the side walls 23 abuts against the upper face of the insulator 11 downwardly. The outer faces of the stopping tabs 231 are coplanar with corresponding outer face of the side walls 23. The stopping tabs 231 further includes guiding faces 232 so as to facilitate the assembly of the pick-up cap 20 onto the insulator 11. The insulator 11 also includes two fixing posts 112 extending downward from the lower face of the insulator 11, and the two fixing posts 112 are adjacent to the two latch grooves 111 respectively, so as to make the electrical connector 10 to be firmly fixed to the circuit board.

Combined with FIG. 3, when the pick-up cap 20 is mounted to the insulator 11, the latch arms 24 can deform elastically as the latch arms 24 and the corresponding end walls 22 are gapped, so the insulator 11 is tightly restrained between the two latch arms 24 along the first direction X-X, the insulator 11 are clamped by pairs of stopping tabs 231 in the second direction Y-Y and in the upper and lower direction perpendicular to the first direction X-X and the second direction Y-Y. The insulator 11 are locked with the latch heads 241 of the latch arms 24 upwardly, therefore, the pick-up cap 20 is firmly fixed to the insulator 11.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector assembly comprising:
an electrical connector comprising a longitudinal insulator with two distal ends and a plurality of terminals retained in the insulator; and
a pick-up cap extending longitudinally with two distal ends along a longitudinal direction thereof and having two latch arms connected with corresponding distal ends respectively;
wherein each of the latch arms has a latch head at a lower end thereof and an operating portion at an upper end thereof, the insulator has two latch grooves at the two distal ends thereof respectively, and the latch heads engage with corresponding latch grooves respectively to lock the pick-up cap on the insulator.

2. The electrical connector assembly as claimed in claim 1, wherein the latch grooves open outward along the longitudinal direction and downward but not penetrate an upper face of the insulator.

3. The electrical connector assembly as claimed in claim 1, wherein two connecting portions extend from opposite sides of each of the latch arms and united with corresponding distal end of the pick-up cap.

4. The electrical connector assembly as claimed in claim 1, wherein the latch arms are gapped with corresponding distal ends of the pick-up cap by a deformation space, the two distal ends of the insulator extends beyond the corresponding distal ends of the pick-up cap and into the deformation space.

5. The electrical connector assembly as claimed in claim 1, wherein the pick-up cap comprises a baseboard, and two longitudinal walls and two lateral walls extending from the base board downwardly, and the two longitudinal walls are connected with the two lateral walls.

6. The electrical connector assembly as claimed in claim 5, wherein the pick-up cap has a plurality of stopping tabs extending downward from a lower face of the longitudinal walls, and the insulator is restrained between insides of the stopping tabs.

7. The electrical connector assembly as claimed in claim 6, wherein the stopping tabs are coplanar with corresponding longitudinal walls at outsides thereof, but not coplanar with corresponding longitudinal walls at insides thereof.

8. The electrical connector assembly as claimed in claim 6, wherein the lower face of the longitudinal walls abut against an upper face of the insulator.

9. The electrical connector assembly as claimed in claim 1, wherein the insulator has two fixing posts extending downward from a lower face thereof and located adjacent to corresponding latch grooves respectively.

10. An electrical connector assembly comprising:
an electrical connector comprising an insulator having an upper face and a lower face and a plurality of terminals retained in the insulator; and
a pick-up cap covering the upper face of the insulator and having two latch arms disposed at two opposite end faces thereof in a first direction; wherein
each of the latch arms extends in an upper-lower direction and has a latch head at a lower end thereof protruding inwards in the first direction and an operating portion at an upper end thereof protruding outward in the first direction;
each of the latch arms is connected with a corresponding end face of the pick-up cap by two connecting portions and gapped with corresponding end face to define a deformation space; and
two end faces of the insulator are located in corresponding deformation spaces, and the latch heads are locked with the insulator upwardly respectively.

11. The electrical connector assembly as claimed in claim 10, wherein the insulator has two latch grooves opening outward along the first direction and downward but do not penetrate the upper face of the insulator, the latch heads are locked with the latch grooves respectively.

12. The electrical connector assembly as claimed in claim 10, wherein the pick-up cap comprises a base board, and two longitudinal walls and two lateral walls extending downwardly from the base board, the longitudinal walls extend in the first direction and the lateral walls extends in the second direction, and the longitudinal walls are connected with the lateral walls.

13. The electrical connector assembly as claimed in claim 12, wherein a plurality of stopping tabs extend downward from the side walls and are aligned in pairs along the second direction, the insulator is limited between the stopping tabs in the second direction.

14. The electrical connector assembly as claimed in claim 13, wherein each stopping tab has a guiding face at a lower end thereof.

15. The electrical connector assembly as claimed in claim 13, wherein the stopping tabs are thinner than the side walls in the second direction thereby lower face of the side walls abutting against the upper face of the insulator.

16. A pick-up cap used for covering on an electrical connector, comprising:
a base board extending along a first direction and a second direction, the base board being longitudinal in the first direction;
two side walls extending downward from the base board and extending in the first direction;
two end walls extending downward from the base board and extending in the second direction; and
two latch arms disposed at corresponding end walls; wherein
each of the latch arms is gapped with a corresponding end wall and has an operating portion at an upper end thereof and a latch head at a lower end thereof, and the operating portion is lower than an upper face of the base board.

17. The pick-up cap as claimed in claim 16, wherein each of the latch arms is connected with a corresponding end wall by two connecting portions, the connecting portions are substantially perpendicular to the latch arms.

18. The pick-up cap as claimed in claim 16, wherein the latch head goes downwardly beyond a lower face of the side walls and the end walls.

19. The pick-up cap as claimed in claim 16, wherein the pick-up cap has plural stopping tabs extending from lower face of the side walls.

20. The pick-up cap as claimed in claim 19, wherein the stopping tabs are aligned in pairs along the second direction.
